(19) United States
(12) Patent Application Publication
(10) Pub. No.: US 2003/0072265 A1
(43) Pub. Date: Apr. 17, 2003

(54) Traffic manipulation on a computer network - I

(76) Inventors: Andrew Franklin Seaborne, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(21) Appl. No.: 10/267,746

(22) Filed: Oct. 9, 2002

(30) Foreign Application Priority Data
Oct. 11, 2001 (GB) 0124363.3

(51) Int. Cl. H04J 1/16; H04B 7/212

(52) U.S. Cl. 370/235; 370/442

(57) ABSTRACT

In order to manipulate traffic flow on a computer network 10 traffic is added in a predetermined pattern.

### FIELD OF THE INVENTION

This invention relates to a method of manipulating traffic on a computer network and to a computer network having traffic manipulation capabilities.

### BACKGROUND OF THE INVENTION

Data traffic on a computer network, which may typically use the TCP/IP protocol is structured. The structure arises on various timescales, such as a short timescale as a result of the TCP/IP ramp, on a medium timescale from bursts of sending complete documents, and a long term timescale as a result of the coupled nature of communications, e.g. from computer A to computer B, computer B to computer C, and computer C to computer A and so on, as in an Ethernet loop.

The basis of traffic transport on computer networks relies on data streams being uncorrelated and random. As set out above, this is not the case, because there is structure on various timescales.

An existing solution to this problem has been provided by the degree2 product (see for example www.degree2.com), which is a switch located at a local area network (LAN)/wide area network (WAN) interface. The switch uses queuing, rate limiting and traffic shaping mechanisms in order to manipulate traffic flow. The main intention of the degree2 product is to ensure WAN utilisation and fair resource allocation to network applications.

Problems arise with the previous solution in that it is expensive to implement.

It is an object of the present invention to address the above mentioned disadvantages.

### SUMMARY OF THE INVENTION

According to a first aspect of the present invention a method of manipulating traffic flow on a computer network includes adding traffic to the network in a predetermined pattern.

The method of manipulating traffic may be a method of manipulating traffic to increase throughput on the computer network.

The traffic flow may be a flow of packets of data, preferably using a TCP/IP protocol. The computer network may be a local area network (LAN), which preferably includes a wide area network (WAN) connection.

The additional traffic may seek to randomise the flow of traffic on the computer network. The additional traffic may be introduced to seek to cause the traffic on the computer network to conform to, or approach, a negative exponential distribution, or an Erlang or hyperexponential distribution.

The additional traffic may be introduced at fixed intervals. The amount of additional traffic may be 5% to 20%, preferably approximately 10%, of the traffic on the computer network. The additional traffic may be introduced in every tenth traffic slot.

The additional traffic may be introduced to break up long bursts of traffic.

The additional traffic may be introduced to cause a mean rate, standard deviation, Hurst parameter and/or another statistical parameter to approach values for random traffic.

The additional traffic may have a default destination, which may be to a traffic manipulation device. The additional traffic may be generated by a ping function, preferably an injection thereof.

The additional traffic is preferably introduced by a traffic manipulator device. The traffic manipulator device is preferably connected to a local computer network. The traffic manipulator device may be connected to a WAN or to a WAN connection.

The traffic may be manipulated to improve the flow of traffic to the WAN.

According to a second aspect of the invention a traffic manipulation device is operable to introduce traffic into a computer network in a predetermined pattern to improve throughput of traffic on said computer network.

The computer network may be a local network and/or a wider network.

The traffic manipulation device may have connection means, such as a LAN connection, operable to connect the device to a computer network, which may be a LAN. The traffic manipulation device may have connection means, such as a WAN connection, for connecting the device to a WAN connection.

The traffic manipulation device may include traffic detection means, which may be an Ethernet card.

The invention extends to a computer network operable to perform the method of the first aspect and/or having a traffic manipulation device according to the second aspect.

The invention extends to a recordable medium bearing a computer program operable to perform the method of the first aspect.

All of the features described herein may be combined with any of the above aspects, in any combination.

### BRIEF DESCRIPTION OF THE DRAWINGS

Specific embodiments of the present invention will now be described, by way of example, and with reference to the accompanying drawings, in which:

FIG. 1 is a schematic view showing a traffic manipulation device attached to a computer network; and

FIG. 2 is a schematic view of a second embodiment of the traffic manipulation device attached to a computer network.

### DESCRIPTION OF PREFERRED EMBODIMENTS

In order to improve the performance and the predictability of performance of a computer network 10, including computers 16, traffic is injected into the network 10 by a traffic manipulator 12.

The traffic manipulator 12 is added to the computer network 10 and may be implemented as a separate box, and/or may be implemented by an addition of software to one or more of the entities 16 sharing the network.

The basis of the action of the traffic manipulator 12 is to manipulate the traffic on the computer network 10 by generating extra traffic.

Any extra traffic that is added to the network is given a default destination and extra traffic is sent to that destination. An alternative is to exploit the known “ping” response, with the additional traffic being in the form of pings.

The pattern of the extra traffic added to the computer network 10 is carefully chosen and the careful choice allows manipulation of the properties of the remainder of the traffic.

This may be achieved by imposing packets at fixed intervals, for example every tenth traffic slot, to surprisingly thereby lower the peak traffic rates from users of the computer network 10. It is has been found that adding, for example 10% additional fixed rate traffic can actually increase the throughput in a shared TCP/IP system, such as the computer network 10. Equally, by putting in additional traffic with particular probabilistic properties (being a convolution of network traffic and a distribution of times) distributed, for example as an exponential, similar results can be achieved. Alternatively, a distribution of traffic chosen against existing traffic patterns from the computer network 10 can be used. A suitable probabilistic test for providing randomness may be one of F, 2, Chi or G-Het distributions.

Such actions may manipulate the properties of the rest of the traffic, such properties may include mean rate, standard deviation, the Hurst parameter (a measure of self-similarity), to approach those parameters more closely corresponding to a random distribution.

More generally, it is desired to manipulate the traffic to conform to a negative exponential distribution (in which the standard deviation is equal to the mean), or an Erlang, or hyperexponential distribution. These distributions are preferred to the self-similar pattern occurring in bursts which is currently found on typical computer networks. A burst can be the size of a file, perhaps up to 4 GB in typical systems, but may be unlimited. The length of a burst in time is the file size divided by transmission rate.

The traffic patterns on the computer network 10 are manipulated in order to achieve deliberately randomised traffic. This is because currently, patterns of traffic within networks are particularly difficult to predict. However, a surprising effect is that random traffic is more straightforward to predict.

In order to achieve the above, the traffic in the local network 14 passing to a wide area network (WAN) via a WAN connection 18 is intended to have the property of randomness to permit prediction, never exceeding a particular bandwidth limitation; also, long bursts should be broken up to allow others access. In addition, back-off strategies in some systems can be exploited to ensure fairness. Such back-off strategies may include using a retry with fixed probability at each future retry instant, or retry with a geometrically shrinking probability after a collision. Further information on back-off strategies can be found in IEEE standard 802.3, which relates to the Ethernet standard.

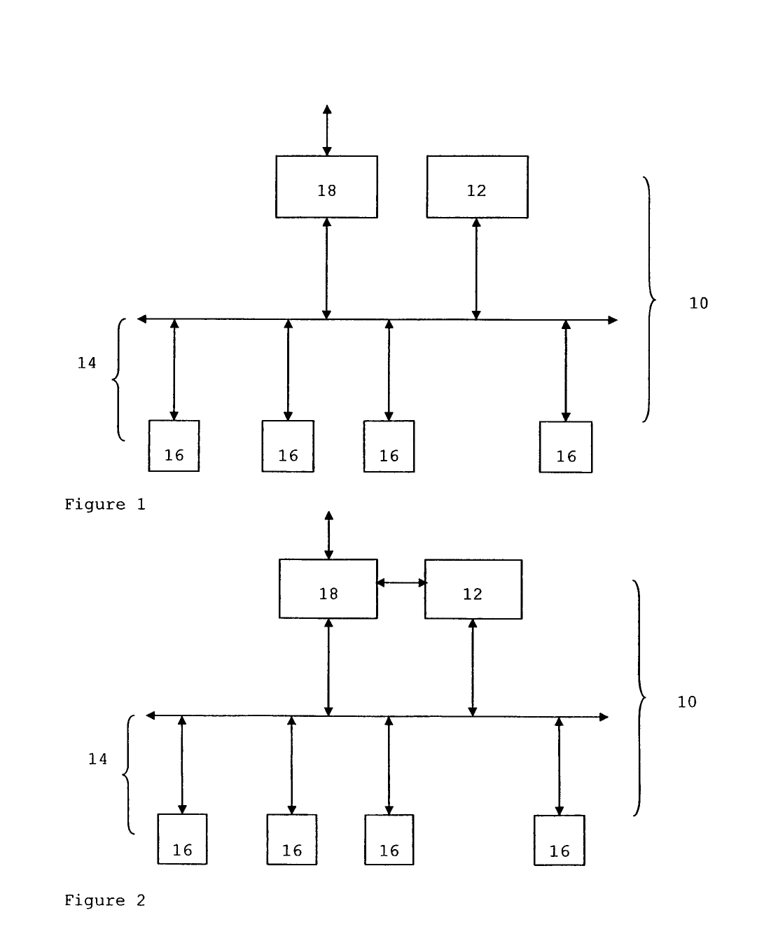

FIG. 2 shows an alternative embodiment of the traffic manipulator 12 in which the traffic manipulator 12 is connected to observe this state of an outgoing link, such as the WAN connection 18. In FIG. 2 those parts in common with FIG. 1 are given the same reference numerals. By allowing the traffic manipulator 12 to observe both the local network 14 and the WAN connection 18 more subtle traffic control can be performed. Such traffic control may include the detection of the onset of outgoing traffic to the WAN connection 18 having the poor properties detailed above, such as poor mean rate, standard deviation or Hurst parameter (a measure of self-similarity). After that detection, a response is generated to control the pattern of traffic on the computer network 10, by the addition of traffic.

One form of action would be to block specific senders of information on to the computer network 10 known to generate traffic having poor qualities.

In addition, the traffic manipulator 12 connected to both the local network 14 and wide area connection 18 can determine whether points in the capacity/shape of data on the computer network 10 are being reached which can cause problems for the network beyond the WAN connection 18. This may have particular benefit if in the future telecommunications companies see benefits in pricing contracts in terms of both peak amounts of traffic and traffic pattern in order that those companies can plan capacity effectively.

Thus, in situations where the traffic on the local network 14 is likely to cause problems for the WAN connection 18 the traffic on the local network 14 can be manipulated by the addition of extra traffic to ease problems related to the WAN connection 18.

Easing problems with the WAN connection 18 has advantages, because of the expense of this resource.

The solution described above advantageously takes advantage of properties of the local network and gives a much cheaper implementation than previous attempts to solve the same problem. By dealing with traffic at the level of the local network greater flexibility of control is given. Also, the solution does not require the change of any of the current elements within the computer network. Instead the retry properties of the network are exploited. In particular, the retry properties of the network 10 can be exploited to give predictable performance within a local network 14 without changing any of the software or hardware of the other components.

1. A method of manipulating traffic flow on a computer network includes adding traffic in a predetermined pattern.

2. A method as claimed in claim 1, which is a method of manipulating traffic to increase throughput on the computer network.

3. A method as claimed in claim 1, in which the additional traffic seeks to randomise the flow of traffic on the computer network.

4. A method as claimed in claim 1, in which the additional traffic is introduced to seek to cause the traffic on the computer network to conform to, or approach, a negative exponential distribution.

5. A method as claimed in claim 1, in which the additional traffic is introduced at fixed intervals.

6. A method as claimed in claim 5, in which the additional traffic is introduced in every tenth traffic slot.

7. A method as claimed in claim 1, in which the additional traffic is introduced to break up long bursts of traffic.

8. A method as claimed in claim 1, in which the additional traffic is introduced to cause a mean rate, standard deviation, Hurst parameter and/or another statistical parameter to approach values for random traffic.

9. A method as claimed in claim 1, in which the additional traffic has a default destination.

10. A method as claimed in claim 1, in which the additional traffic is introduced by a traffic manipulator device.

11. A method as claimed in claim 10, in which the traffic manipulator device is connected to a local computer network.

12. A method as claimed in either claim 10, in which the traffic manipulator device is connected to a wide area network (WAN).

13. A method as claimed in claim 1, in which the traffic is manipulated to improve the flow of traffic to a WAN.

14. A traffic manipulation device is operable to introduce traffic into a computer network in a predetermined pattern to improve throughput of traffic on said computer network.

15. A traffic manipulation device as claimed in claim 14, which has connection means operable to connect the device to a computer network.

16. A traffic manipulation device as claimed in claim 15, in which the connection means is a local area network (LAN) connection and/or a wide area network (WAN) connection.

17. A traffic manipulation device as claimed in claim 14, which includes a traffic detection means.

18. A traffic manipulation device as claimed in claim 17, in which the traffic detection means is an ethernet card.

19. A computer network is operable to perform the method of claim 1 and/or has a traffic manipulation device according to claim 14.

20. A recordable medium bearing a program operable to perform the method of claim 1.
